(19) United States
(12) Patent Application Publication
(10) Pub. No.: US 2013/0000829 A1
(43) Pub. Date: Jan. 3, 2013

(54) POLYMERIC SUBSTRATE WITH LAMINATED GLASS LAYER

(75) Inventor: Yoash Carmi, Kibbutz Eilon (IL)

(73) Assignee: HANITA COATINGS R.C.A. LTD, Kibbutz Hanita (IL)

(21) Appl. No.: 13/634,245

(22) PCT Filed: Mar. 17, 2011
(86) PCT No.: PCT/IL2011/000262

§ 371 Date: Sep. 12, 2012

Related U.S. Application Data
(60) Provisional application No. 61/314,925, filed on Mar. 17, 2010.

(51) Int. Cl. B32B 37/02; B32B 37/06; B32B 38/14; B32B 37/12

(52) U.S. Cl. 156/230

(57) ABSTRACT

A method for producing glass-polymer laminates is provided. The method includes applying a glass fit material onto a transfer substrate to form a coated substrate, exposing the coated substrate to a temperature above the melting temperature of the glass frit material to form a glass layer on the transfer substrate, laminating the glass layer film and a polymer substrate and removing the transfer substrate from the glass layer to form a glass-polymer laminate.

### BACKGROUND

Polymeric materials are used for many applications and products due to the advantageous properties of the material. Such advantages may include, for example, a relatively low material cost, flexibility, and resistance to breaking or shattering when subjected to stress or struck. Thus, polymer materials are sometimes used as a support layer for various devices, such as filters, solar cells and electronic devices.

The polymer material, however, may be damaged when exposed to the external environment by acidic gases, atmospheric oxygen or ultraviolet radiation. In addition, a polymer material may be scratched if brought into contact with an abrasive or sharp material. Such contact may result from routine handling or cleaning of a product, or from exposure to airborne or blown sand or dust particles. In addition, polymeric materials are not suitable as a barrier to permeation of atmospheric gases.

A glass, on the other hand, is often resistant to many of the environmental factors that may damage a polymer material. Common types of glass include, but are not limited to, soda-lime glass, borosilicate glass, boron or phosphorous doped glass, silicon dioxide, silicon nitride and aluminum oxynitride. Glass is typically unaffected by exposure to gaseous components of the atmosphere, to caustic materials, or to ultraviolet radiation. Glass has high thermal and dimensional stability and other beneficial properties compared to polymeric materials. For example, glass has extremely low permeability to moisture vapor and other gases, excellent hardness and scratch resistance, high transparency and very high chemical durability.

However, glass in many of its forms is relatively inflexible and brittle, being subject to breaking or shattering when stressed or struck. Due to the low flexibility of glass, glass sheets are not used for the manufacturing of flexible products. Further, standard glass sheets are rather thick and therefore relatively heavy.

Production processes involving glass are typically carried by application of a batch process (plate by plate). Coating and lamination processes of a polymeric film, on the other hand, are typically performed by using roll-to-roll processes. Productivity and cost efficiency of continuous roll-to-roll coating and lamination processes are significantly higher than batch processes.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 schematically illustrates an exemplary roll-to-roll process for producing of a glass-laminated polymer substrate according to embodiments of the invention; and

FIG. 2 schematically illustrates a portion of an exemplary process for producing of a glass-laminated polymer substrate according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the present invention are directed to a method for producing glass or glass-based films laminated to polymeric substrates. The glass-polymer laminates manufacture according to embodiments of the invention may include a polymeric substrate and a flexible thin glass-based film or a glass skin with a thickness of less than 50 microns. The resulting laminate may be suitable, for example, for use in the production of a variety of flexible optical and electronic products, and for use as a scratch resistant coating to polymeric substrates.

Non-exhausting examples of suitable applications include organic light emitting diodes (OLED's), solar cells, liquid crystal displays (LCD's), optical filters, sensors, or touch screens. Glass-laminated polymer substrates may also serve as plastic sheets, or as plastic foils laminated to metallic or plastic objects, and as window films. In such applications, the properties of the glass skin in the laminate may provide an advantage over a polymeric substrate without such lamination.

The glass film of the laminate may have desired properties such as transparency, mechanical flexibility, resistance to gas permeation (such as oxygen, nitrogen and water vapor), scratch resistance, a smooth surface, and durability under exposure to chemical agents, UV or any other radiation and mechanical stresses or impacts.

In accordance with embodiments of the present invention, such a laminate may be fabricated using various mass production techniques, such as by roll-to-roll, roll-to-sheet, sheet-to-roll or sheet-to-sheet processes. Glass frits are first deposited on a transfer substrate, for example a metal foil, to form a glass film. The transfer substrate should be capable of withstanding elevated temperatures (above 500° C.) required for the glass firing process. The glass film on the transfer substrate is then laminated or bonded to a surface of a polymer substrate, e.g. by using a suitable glue substance. The transfer substrate is then separated from the glass film, e.g. by etching or mechanically peeling the transfer substrate. After removal of the transfer substrate, a glass-laminated polymer substrate remains. The removal of the transfer substrate may be performed by peeling off, chemical etching, electrochemical etching or dissolving.

For example, such a process may include depositing a glass fit composition on a metal foil to form a glass film on the foil. Glass frit is a glass based ceramic composition. A glass fit composition may be prepared by mixing and fusing the components in a dedicated high temperature smelting oven, quenching the fused material in cold water to form a glass, and granulating the formed glass into a powder form. Exemplary compositions of glass fit may include one or more of lead-based glass Bi2O3 based glass frit, zinc oxide-based glass fit, Bi2O3 and zinc oxide-based glass frit, and mixtures thereof. Typical particle size of glass frit is 3 to 20 microns, as measured by laser obstruction method or by scanning electron microscopy. Throughout the specification and the claims the terms “glass” and “glass-based” are interchangeably used and may refer to any glass-based composition including, but not limited to, compositions containing bismuth oxide, silicon dioxide, a non-crystalline bismuth silicate, zinc oxide, borosilicate, lead, alumina or zirconium.

According to embodiments of the invention the glass-laminated polymer film may be flexible, namely capable of being rolled. The glass-laminated polymer may be suitable for a variety of applications, such as, for example, organic light emitting diodes (OLED), solar cells, liquid crystal displays (LCD), optical filters, sensors, or touch screens. Glass-laminated polymer substrates may also serve as plastic sheets, or as plastic foils laminated to metallic or plastic objects, and as window films. In such applications, the properties of the glass in the laminate may provide an advantage over a polymeric substrate without such lamination.

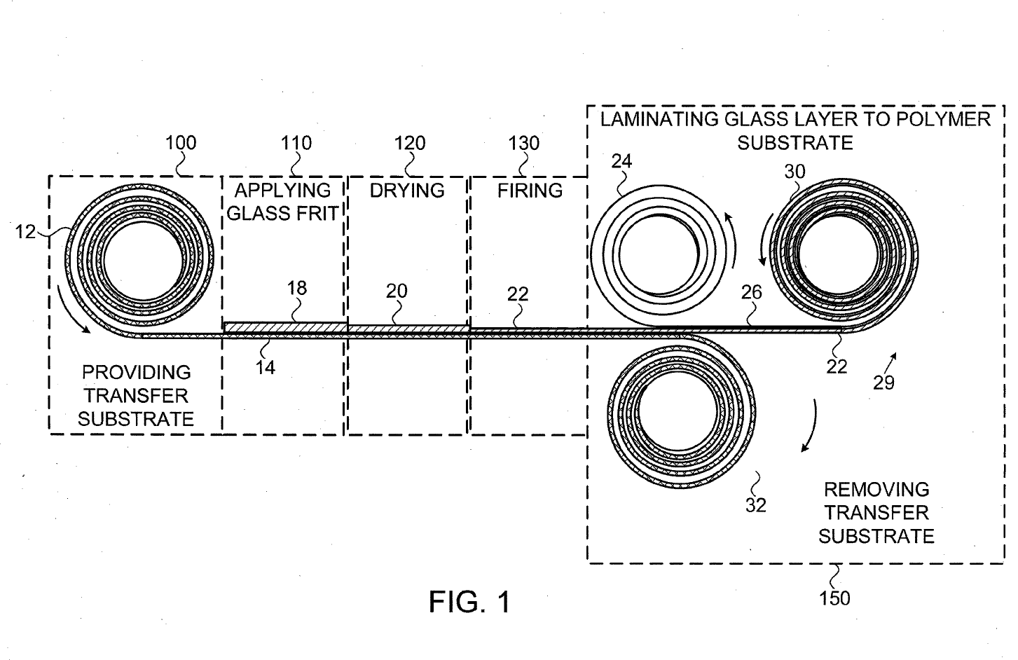

Reference is now made to FIG. 1, which schematically illustrates an example of a roll-to-roll process for producing of a glass-laminated polymer foil according to embodiments of the invention. This process produces a laminated structure in a form of a roll 29 that includes a polymeric substrate 26 coated with a glass-based layer 22. In some embodiments, the glass-based layer may have a thickness of no more than 25 micrometers. In some embodiments, the glass-based layer may have a thickness of no more than 10 micrometers. In some embodiments, the glass-based layer may have a thickness of no more than 6 micrometer. In other embodiments, the glass-based layer may have a thickness of between 0.1 micrometer and 0.5 micrometers.

According to embodiments of the invention, the method may include providing a transfer substrate (box 100). In some embodiments, a transfer substrate 14, which may be, for example, a metal foil may be continuously wound in a form of a roll. Instead, transfer substrate may be provided from a similar continuous source of substrates, such as a foil extruding device. Substrate transfer 14 may be moved continuously during the production process or may stop at predetermined intervals. Alternatively, sheets of transfer substrate material may be used in the manufacturing process. Although, for clarity and ease of explanation only a roll of transfer substrate is described with respect to FIG. 1, it should be understood to a person skilled in the art that embodiments of the invention are not limited in this respect and the use of discrete sheets is within the scope of the invention. For example, a discrete sheet-to-sheet process may be suitable for a substrate, such as a rigid panel, that is not amenable to manufacture using a roll-to-roll process.

The material and/or thickness of transfer substrate 14 may be determined by the demands of the process. Considerations in determining a choice of the material and the characteristics of the transfer substrate may include, for example, cost, weight, ease of handling, ability to withstand temperature or other environmental conditions of the process, ease of etching or peeling off and ability to be recycled. Non-exhaustive examples of transfer substrates may include metal foils, such as, for example, copper, nickel, aluminum, zinc, stainless steel, chrome, steel, iron, or brass, or various mixtures or alloys of the above. According to embodiments of the invention, the thickness of a suitable metal foil may range from 0.1 microns to 500 microns.

The method may include applying a glass frit-based material containing glass or glass-based particles to a surface of the transfer substrate (box 110) to form a coating layer. The layer may be printed as a patterned layer or alternatively a uniform layer. In some embodiments, the surface of the transfer substrate may be pre-coated with a priming layer. The glass frit-based material may be a liquid inkjet composition with glass frit particles suitable for inkjet deposition. Inkjet printing may be understood to include drop-on-demand, thermal, or continuous ink jet printing.

In some embodiments, the glass layer may be applied to the transfer substrate using other methods. Such alternative methods may include, for example, screen printing, roller printing/coating, spray coating, dip coating, curtain coating, gravure, or flexographic printing/coating.

The composition of glass frit material may be selected so as to attain a desired viscosity of the material. For example, for the purpose of inkjet printing, a glass frit composition may be formulated with a viscosity in the range of 1 cPs to 30 cPs. In some embodiments, the viscosity of the composition may be 10 cPs to 30 cPs, at jetting temperature. In some embodiments, the viscosity of the composition may be 15 cPs to 25 cPs, at jetting temperature. In some embodiments, the viscosity of the composition may be in the range of 1 cP to 10 cP, at jetting temperature. In some embodiments, the viscosity of the composition may be in the range of 3 cP to 5 cP, at jetting temperature.

A composition for a screen printing paste may have a viscosity in the range of 5,000 cPs to 50,000 cPs, for example in the range of 10,000 cPs to 30,000 cPs, at room temperature.

According to embodiments of the invention, the process may continue with drying the deposited liquid composition at a temperature between 20° C. 250° C. (box 120). During the drying operation, liquids are evaporated from the layer. The drying may be active, e.g. by operating a cooling or heating device or may be passive. Drying of deposited layer 18 forms a dried glass frit layer 20.

The process then may continue with calcinating or firing the dried layer 20 at a temperature above the melting temperature of the glass frit (box 130) The material is then cooled down to produce glass film 22 on transfer substrate 14. The calcination temperature may be in the range of 300° C. to 1200° C. depending on the composition and properties of the glass frits. The calcinating operation may be performed in a suitable oven or suitable radiative, conductive, or convective heating device. In some embodiments, the dries glass frit layer may be heated to a temperature of approximately 650° C. In other embodiments, the dries glass frit layer may be heated to a temperature in the range of 650° C.-750° C. The temperature may be carefully controlled to achieve desired required optical and mechanical qualities of glass film 22 after firing. Typical calcination temperatures may be well above the melting or decomposition temperature of many polymeric substrates.

The thickness of glass film 22 may be approximately 20 microns or less. Such a small thickness may enable glass film 22 to be bendable or flexible, while retaining its impermeability and scratch resistance properties.

According to embodiments of the invention, the process may continue with a lamination process (box 140). Glass film 22 may be laminated to a polymeric substrate sheet 26. Polymeric substrate 26 may be include one or functional layers.

Polymeric substrate 26 may be dispensed or otherwise provided in a continuous manner by a roll 24 or any continuous source of a polymer substrate, e.g. an extruding device for extruding a polymer substrate. Alternatively, sheets of polymeric substrate material may be used in the manufacturing process. Although, for clarity and ease of explanation only a continuous polymeric sheet wound in a form of a roll is described with respect to FIG. 1, it should be understood to a person skilled in the art that embodiments of the invention are not limited in this respect and the use of discrete polymeric sheets is within the scope of the invention.

Polymeric substrate sheet 26 may include a film or sheet of polyester (PET), polycarbonate (PC), polyvinylchloride (PVC), polyethylene naphthalate (PEN), poly(methyl methacrylate) (PMMA), acrylic, silicone, acrylonitrile butadiene styrene (ABS), polyamide (PA), polyimide (PI), poly(ether) sulphone, and various mixtures and laminates of the above.

According to embodiments of the invention, the lamination of glass film 22 to polymeric substrate sheet 26 may include bonding between glass film 22 and polymeric substrate sheet 26 by introducing a suitable adhesive to glass film 22, polymeric substrate sheet 26, or both. For example, a lamination adhesive layer may be based on polyurethane, acrylic, epoxy, or ethylene vinyl acetate (EVA). It should be understood, however to a person skilled in the art that embodiments of the invention are not limited in that respect, For example, in some embodiments, the lamination process may include a hot lamination process, hot melts process or any other suitable lamination techniques.

The exposed surface of glass film 22 and polymeric substrate sheet 26 may be brought into contact or pressed together in order to form a bond between them. Thus, glass film 22 may be sandwiched between polymeric substrate sheet 26 and transfer substrate 14. Then, according to embodiments of the invention, the transfer substrate 14 may be removed from the glass film 22. It should be understood to a person skilled in the art that the removal of the transfer substrate may be performed concurrently with the lamination process such that the exposed surface of the glass film is laminated while the transfer substrate is removed from the other surface of the glass film. In other embodiments, removal of the transfer substrate may be performed concurrently with the lamination process such immediately after laminating the polymeric substrate and the glass film on a portion of the continuous sheets, the transfer substrate may be removed from the laminated portion.

According to embodiments of the invention, transfer substrate or metal foil 14 may be removed or separated from glass film 22 by applying force that causes the transfer substrate to be peeled off the glass film or skin (box 150). For example, an adhesion force between the metal foil and the glass film may be sufficiently small to allow a small force applied approximately normal to the interface between them to cause them to separate. For example, a suitable approximately normal force may be applied by metal foil take-up reel 32, laminated sheet take-up reel 30, or both.

In some embodiments of the present invention, a separation device (not shown) may be applied to assist in separating metal foil 14 from glass film 22. For example, the separation device may represent a mechanical device such as a wedge or knife edge. Alternatively, the separation device may, for example, represent a thermal device that assists in separation by heating or cooling an interface between metal foil 14 and glass film 22. Alternatively, the separation device may, for example, represent a fluid device that injects a fluid (e.g. a suitable gas or liquid) into an interface between metal foil 14 and glass film 22. The separation device may, for example, represent a combination or array of separation devices that operate on the basis of various principles. As another example, peeling may be facilitated by cooling or heating metal foil 14, glass film 22, or both.

In some embodiments of the present invention, a priming coating layer may be applied to the surface of the transfer substrate 14 prior to deposition of deposited glass frit material 18. The coating may reduce or inhibit adhesion of glass film 22 to transfer substrate 14, which may be a metal foil. Thus, the coating may facilitate peeling off metal foil 14 from glass film 22. Alternatively, metal foil 14 may be scraped off of glass film 22.

For example, the priming layer may include an organic, metallic, oxide, or nitrate material. The primer layer may be deposited either in-line as part of the production process or metal foil 14 may be provided with such a coated layer already applied. The primer coating layer may weaken the strength of a bond formed between metal foil 14 and glass film 22. The layer may include such inorganic materials as, for example, metals, oxides, nitrides, or alloys thereof. If metal foil 14 is a copper foil, for example, the primer coating may include a layer of elemental tin, copper, copper oxide, aluminum oxide, nickel-copper alloy, or zinc-copper alloy. Alternatively, the priming coating may include an organic decoupling agent, such as an amino silane, an epoxy silane, or a mercapto silane.

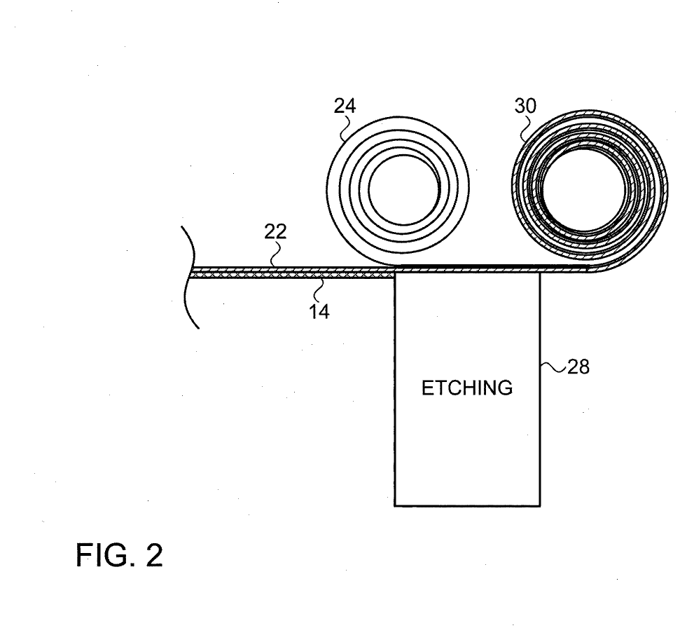

Reference is additionally made to FIG. 2 showing another embodiment describing the removal operation. According to some embodiments, the transfer substrate may be removed by a chemical etching process or electrochemical stripping 28. For example, process 28 may include a chemical etching, or electrochemical, bath through which laminate 31 is passed. Etching agents of the chemical etching bath may be selected so as to etch metal foil 14, while leaving glass film 22 and polymeric substrate sheet 26 intact. Alternatively, etching process 28 may be understood to include any other process in which metal foil 14 is dissolved, vaporized, sublimated, abraded, or chemically removed while leaving glass layer 22 and polymeric substrate sheet 26 intact. For example, metal foil 14 may be selectively heated by a laser or electromagnetically so as to selectively sublimate metal foil 14. As another example, metal foil 14 may be subjected to an abrading stream of particles such that the particles abrade metal foil 14 while leaving glass film 22 intact.

Referring back to FIG. 1, the remaining laminated structure 29 includes thin glass layer 26 adhering to polymeric substrate sheet 26. For example, laminated structure 29 may be in the form a flexible sheet. The finished laminated structure 29 may be collected by a suitable device, such as laminated sheet take-up roll, in the case of a flexible sheet. Collecting laminated structure 29 may include cutting or shaping laminated structure 29 into a suitable shape in accordance with an intended application.

According to some embodiments of the present invention, a process for producing a glass laminated polymer substrate need not be limited to depositing only a single layer of glazing material. For example, additional layers of glass frits may be deposited on a metal foil. The extra layers of glass frits may be deposited before firing the first layer, or subsequently to firing the first layer. Alternatively or additionally, in some embodiments, more than one glass layer may be laminated to the substrate, one on the top of the other. Such multi-layering may help to minimize a number of pinholes caused in the glass film, or may improve the mechanical properties of the glass lamination. In accordance with some embodiments of the present invention, a glass laminated polymer substrate may provide a lighter alternative to glass sheet and laminates.

### Glass Frits

The glass frit contained in layer 18 may include any known glass frit based on oxides chosen for example, from bismuth, silicone, lead, titanium, zinc, boron, zirconium, sodium, lithium, aluminum, tin, potassium, calcium, vanadium, magnesium and any combination thereof. For example, the glass frit may contain bismuth oxide, silicon dioxide, a non-crystalline bismuth silicate, zinc oxide, borosilicate, lead, alumina or zirconium containing frits. A blend of two or more glass frit materials may be employed in order to obtain a composition having desired properties (e.g. glass properties or processing parameters). Selection of a component of deposited glass fit material 18 may also take into consideration other considerations, such as environment considerations. For example, lead-free frits may be selected in response to environmental considerations.

Typical concentrations of glass frit material in a glass frit ink are in the range of 1% to 90% w/w % based on the total weight of the composition. For example, depending on the thickness desired for glass film 22, the glass frit ink may be in the range of 10% to 70% w/w % based on the total weight of the composition. In some embodiments, the glass fit ink may be in the range of 0% to 50% based on the total weight of the composition.

The glass fit composition may include a binder component. A typical mass concentration of the binder, based on the total weight of the composition, may be in the range of 0.1-30 w/w %. In some embodiments, the concentration of the binder may be in the range of 1-10 w/w %. The composition may further include a liquid vehicle component. The liquid vehicle may be water-based or solvent-based. For example, a typical water mass concentration, based on the total weight of the composition, may be in the range of 10-99 w/w %. In some embodiments, the liquid vehicle may be in the range of 30-50 w/w %, based on the total weight of the composition.

The glass fit composition may include additional components such as wetting agents, anti-foaming agents, humectants, rheology control agents, or fixation agents. The composition of deposited glass frit material 18 may be adjusted so as to be compatible with, or optimized for, a particular coating or deposition method. For example, a composition may be selected such that a viscosity of the material may be suitable for a particular coating or deposition method.

A composition of a glass fit material may include one or more pigments or chemical substances that form color. Inclusion of a pigment together with the glass frits enables tinting the laminate. Inclusion of a pigment may enable controlling optical properties of the glass layer, such as, for example, selective transmission, reflection, or absorption of electromagnetic radiation. A pigment may be selected such that its properties remain stable when the glass frit material is calcined. For example, a pigment based on a metal salt may provide such stability. Examples of pigments based on metal salts include cobalt salts to impart a blue tint, iron oxide to impart a red tint, copper salts to impart a blue or green tint, and gold or silver salts to impart a gold or silver color.

A component may be included in the glass fit material such that a chemical reaction at the glass-metal foil interface may introduce a specific color into the glass. For example, a bismuth-based frit printed on a copper foil may receive a red color at the copper-glass interface due to formation of a copper-oxide layer at the interface.

The glass frit material may be selected such that glass film 22 has a refractive index that is approximately matched to a refractive index of the polymeric substrate 26. For example, such refractive index matching may reduce reflection of light at an interface between glass film 22 and polymeric substrate sheet 26. Reducing reflection may enable increasing transmission of light going through laminated structure 29 (e.g. if polymeric substrate sheet 26 is transparent or translucent).

### EXAMPLES

Table 1 shows an example of a glass frit material composition, where component designations are in weight percentages. It is noted that the following example do not limit in any way the scope of the present invention.

TABLE 1

| Weight % | Ingredient |
|---|---|
| 40% | Glass Frit |
| 55% | N-methyl-2-pyrollidone |
| 4.9% | Ethyl Cellulose |
| 0.1% | Additive e.g Zonyl ® of Dupont |

Table 2 below various summarized characteristics of exemplary glass-polymer laminates and the method of manufacturing these laminates. The metal foils employed are commercial foils. For example the Copper foils may be available, for example, from Gould Circuit Foil (Luxemburg), (Cu) and the Aluminum foils may be available for example from Hydro Aluminium Deutschlald Gmbh (Germany). The Glass fits employed may be available, for example from Johnson Matthey BV (Masstricht, the Netherlands). The tin (Sn) thin film coating was employed by thermal vacuum deposition, electroplating or electroless plating.

TABLE 2

| | | | | Wet | | | |
|---|---|---|---|---|---|---|---|
| | | | Firing | Glass | Foil | | Metal foil |
| | | | Temp. | thickness | thickness | Polymer | removal |
| No. | Metal Foil | Frit type | ° C. | μm | μm | film used | method |
| 1 | Copper | Bismuth | 670 | 40 | 100 | Acrylic/ | peeling |
| | | | | | | PET/PEN/ | |
| | | | | | | PC | |
| 2 | Copper | Zinc | 670 | 40 | 100 | Acrylic/ | peeling |
| | | | | | | PET/PEN/ | |
| | | | | | | PC | |
| 3 | Copper | Borosilicate | 670 | 40 | 100 | Acrylic/ | Etching |
| | | | | | | PET/PEN/ | HNO₃, 10% |
| | | | | | | PC | |
| 4 | Aluminum | Bismuth | 620 | 40 | 100 | Acrylic/ | peeling |
| | | | | | | PET/PEN/ | |
| | | | | | | PC | |
| 5 | Aluminum | Zinc | 620 | 40 | 100 | Acrylic/ | Etching HCl, |
| | | | | | | PET/PEN/ | 10% |
| | | | | | | PC | |
| 6 | Aluminum | Zinc | 620 | 40 | 100 | Acrylic/ | Etching |
| | | | | | | PET/PEN/ | NaOH, 10% |
| | | | | | | PC | |
| 7 | Aluminum | Zinc | 620 | 40 | 100 | Acrylic/ | Peeling |
| | | | | | | PET/PEN | |
| | | | | | | PC | |
| 8 | Zn-plated | Bismuth | 670 | 40 | 40 | Acrylic/ | Peeling |
| | copper | | | | | PET/PEN/ | |
| | | | | | | PC | |
| 9 | Zn-plated | Zinc | 670 | 40 | 40 | Acrylic/ | Peeling |
| | copper | | | | | PET/PEN/ | |
| | | | | | | PC | |
| 10 | Sn-plated | Bismuth | 670 | 40 | 20 | Acrylic/ | Peeling |
| | copper | | | | | PET/PEN/ | |
| | | | | | | PC | |
| 11 | Sn-plated | Zinc | 670 | 40 | 20 | Acrylic/ | Peeling |
| | copper | | | | | PET/PEN/ | |
| | | | | | | PC | |

### Applications

A laminated structure of polymeric substrate and a thin glass layer, in accordance with embodiments of the present invention, may be incorporated in a flat panel display that uses LCD or OLED technology. In such displays, a laminated structure of polymeric substrate and a thin glass layer, in accordance with an embodiment of the present invention, may be used in place of the glass plates that are typically used for encapsulation and support for carrying a plurality of functional layers such as color filters, active layers, and conductive layers.

Glass plates used in flat panel displays typically have a thickness of 500 microns to 1500 microns. In many cases, two such glass plates are required in the display. A significant fraction of the weight of the display is determined by the size and thickness of these glass plates. Thus, replacing a thick glass plate with a thinner laminate in accordance with embodiments of the present invention may result in significant reduction in the weight of the flat panel display.

A laminated structure of polymeric substrate and a thin glass layer, in accordance with an embodiment of the present invention, may be utilized in the construction of a flexible solar cell. For example, active components of the solar cell may be printed on the polymeric substrate. The glass layer may provide the solar cell with a transparent encapsulation that enables penetration of light so as to maximize power conversion efficiency. At the same time, the glass layer may provide an impermeable barrier that strongly inhibits permeation of oxygen and moisture that might degrade active layers of the solar cell.

A laminated structure of polymeric substrate and a thin glass layer, in accordance with an embodiment of the present invention may be applied to a window as a film. Such a film may be applied to a window, for example, order to limit solar or other radiation transfer through the window, e.g. to control a temperature or ambient light level in an enclosed space. Such a film may be applied to a window for safety purposes, such as to prevent breaking or shattering of the window upon being impacted or stressed. Windows and there applied films may be subjected to degradation by contact with hard airborne particles, or by exposure to corrosive chemicals that may be present in the air or ultraviolet radiation. Thus, an applied film incorporating such a laminated structure may increase the service life of such a film.

A laminated structure of polymeric substrate and a thin glass layer, in accordance with an embodiment of the present invention, may be in the form of a polymeric sheet. For example, a PC sheet or a PMMA sheet may be laminated with a thin glass layer in accordance with an embodiment of the present invention. Such a thin glass layer on the sheet may enhance resistance of the sheet to scratching and chemical agents.

Such a polymeric sheet with a thin glass layer may be utilized in a product, for example, as a support for carrying functional layers. Such functional layers include, for example, filters, recording layers, and adhesive layers. In some applications, sheets of different materials may be bonded or adhered to one another so as to obtain a laminate material. Such a laminate material may have advantageous properties of various materials making up the various layers. For example, such a laminate structure may be used for security glass applications in windshields and façades.

It should also be clear that a person skilled in the art, after reading the present specification could make adjustments or amendments to the attached Figures and above described embodiments that would still be covered by other embodiments the present invention. It is appreciated that one or more of the steps of any of the methods described herein may be omitted or carried out in a different order than that shown, without departing from the true spirit and scope of the invention.

While the present invention has been described with reference to one or more specific embodiments, and mainly to embodiments describing the manufacturing of a glass-polymer laminate in a roll-to-roll process, the description is intended to be illustrative of the invention as a whole, and is not to be construed as limiting the invention to the embodiments shown. As explained above, it should be understood to a person skilled in the art that embodiments of the present invention may be directed to other processes such as sheet-to sheet and roll-to sheet processes.

It is appreciated that various modifications may occur to those skilled in the art that, while not specifically shown herein, are nevertheless within the true spirit and scope of the invention.

What is claimed is:

1. A method for producing glass-polymer laminates, the method comprising:
applying a glass frit material onto a transfer substrate to form a coated substrate;
exposing the coated substrate to a temperature above the melting temperature of the glass frit material to form a glass layer on the transfer substrate;
laminating the glass layer film and a polymer substrate; and
removing the transfer substrate from the glass layer to form a glass-polymer laminate.

2. The method of claim 1, wherein the transfer substrate is a metal foil and removing the transfer substrate comprises etching the transfer substrate.

3. The method of claim 1, wherein removing the transfer substrate comprises peeling the transfer substrate from the glass layer.

4. The method of claim 1, wherein the glass frit material is applied by inkjet printing.

5. The method of claim 1, further comprising:
providing the transfer substrate wrapped as a roll; and
wrapping the glass-polymer laminate as a roll.

6. The method of claim 1, wherein the glass layer has a thickness of less than 25 micrometers.

7. The method of claim 1, wherein the glass layer has a thickness of less than 6 micrometers.

8. The method of claim 1, wherein the transfer substrate is a metal foil.

9. The method of claim 8, wherein the metal foil comprises copper, nickel, aluminum, zinc, stainless steel, chrome, steel, iron, brass or any combination thereof.

10. The method of claim 1, wherein laminating comprises depositing an adhesive on the glass layer, the polymer substrate or both.

11. The method of claim 10 wherein the adhesive is based on polyurethane, acrylic, epoxy or ethylene vinyl acetate

12. The method of claim 1, wherein laminating comprises using a hot lamination process.

13. The method of claim 1, wherein the transfer substrate is coated with a priming coating for hindering adhesion between the transfer substrate and the glass layer.

14. The method of claim 1, wherein the glass frit material comprises one or more of: lead-based glass frit, bismuth-based glass frit, zinc-based glass frit, bismuth and zinc oxide-based glass frit, borosilicate frit, zinc borosilicate frits alumina or zirconium-based fit.

15. The method of claim 1, wherein the glass layer has a refractive index which is substantially matched to the refractive index of the polymer substrate.

16. The method of claim 1 wherein the glass frit material comprises at least one pigment or a color forming chemical substance.

17. The method of claim 1, wherein the glass frit material is applied to the transfer substrate by screen printing, roller printing, spray coating, curtain coating, dip coating, gravure or flexographic printing.

18. The method of claim 1 wherein applying the glass frit material comprises printing in a pre-designed pattern.

19. The method of claim 1, comprising laminating an additional glass layer to the glass-polymer laminate.

20. The method of claim 1, comprising forming an additional glass layer ton the transfer substrate.
